(19) United States
(12) Patent Application Publication
(10) Pub. No.: US 2002/0008927 A1
(43) Pub. Date: Jan. 24, 2002

(54) Connection apparatus for enabling an operative condition between a video cassette recorder and a camcorder

(75) Inventors: Jin Woo Park, Sonton (KR); Yong Taik Lim, Seoul (KR)

Correspondence Address: CHRISTIE, PARKER & HALE, LLP, 350 WEST COLORADO BOULEVARD, SUITE 500, PASADENA, CA, 91105, US

(73) Assignee: Goldstar Co., Ltd.

(21) Appl. No.: 09/839,537

(22) Filed: Apr. 20, 2001

Related U.S. Application Data
(63) Continuation of application No. 08/657,640, filed on May 30, 1996, now abandoned.
Application No. 08/657,640 is a continuation of application No. 08/246,294, filed on May 19, 1994, now abandoned.

(30) Foreign Application Priority Data
May 21, 1993 (KR) 93-8774

(51) Int. Cl. G11B 5/86

(52) U.S. Cl. 360/15

(57) ABSTRACT

A dubbing control apparatus which can perform dubbing between a video camera and a fixed video cassette recorder (VCR) with the video camera and the fixed VCR being detachably connected with each other. The apparatus includes connectors, installed on the video camera and the fixed VCR, respectively, for being in contact with each other, the connectors interfacing with a power supply, video and audio signals reproduced/recorded by the video camera and the fixed VCR, and other signals during dubbing, and switching elements for selecting dubbing conditions from the video camera to the fixed VCR and vice versa.

### BACKGROUND OF THE INVENTION

1. Field of the Invention

The present invention relates to a dubbing control apparatus for video appliances such as a video camera and a video cassette recorder (VCR), and more particularly to a dubbing control apparatus which can perform dubbing between the video appliances and the appliances being detachably connected with each other.

2. Description of the Prior Art

Conventionally, the 8 mm camcorder is well known as a portable video camera. This camcorder is a kind of video appliance which, being easily carried by a user, can photograph an object and then record the photographed video signal on an 8 mm video tape. Meanwhile, fixed VCRs have now found their way into almost all homes with television (TV) sets. Generally, the fixed VCR employs a deck for a ½-inch video tape to record/reproduce video signals. Accordingly, the video signal photographed and recorded on the 8 mm video tape by the 8 mm camcorder must be dubbed on the ½-inch video tape in order for the user to view the photographed video signal on a TV screen by way of the fixed VCR. In order to solve this, a multi (double)-deck VCR having two decks, i.e., one deck for the 8 mm tape and another deck for the ½-inch tape, in a single housing has now been developed.

FIG. 1 is a circuit diagram of a conventional multi-deck VCR. Referring to FIG. 1, the multi-deck VCR includes a radio frequency (RF) distributor 1 for distributing an RF television signal inputted through an RF input terminal RFI, a tuner 2 for tuning a broadcasting signal of a predetermined channel in the RF signal outputted from the RF distributor 1, an 8 mm deck 3 and a ½-inch deck 4, both installed in a single housing 9 (not illustrated), for respectively recording/reproducing video and audio signals on an 8 mm video tape and a ½-inch video tape, respectively, a first switching element SW₁ for selecting one among external video signals respectively inputted through external input terminals EI₁ and EI₂ and an output signal of the tuner 2, and providing the selected signal to the 8 mm deck 3 as a recording signal, and a second switching element SW₂ for selecting one among the external signals from the external input terminals EI₁ and EI₂ and the output signal of the tuner 2, and providing the selected signal to the ½ inch deck 4 as a recording signal. The conventional multi-deck VCR is also provided with a third switching element SW₃ for selecting one of the external signals from the external input terminals EI₁ and EI₂, the output signal of the tuner 2, and output signals of the 8 mm deck 3 and the ½-inch deck 4, and providing the selected signal through an external output terminal EO, and a modulator 5 for modulating the output signal of the RF distributor 1 and/or the output signal of the third switching element SW₃ to provide the modulated signal through an RF output terminal RFO.

The operation of the conventional multi-deck VCR as constructed above will now be explained.

The RF signal (i.e, television signal) received by an antenna (not illustrated) and inputted through the RF input terminal RFI is distributed by in the RF distributor 1 to be outputted to the tuner 2 and the modulator 5, respectively. The tuner 2 tunes a predetermined channel broadcasting signal from the input RF signal. Through the external input terminals EI₁ and EI₂, external video signals provided from external video appliances may be inputted.

At this time, if a common contact of the first switching element SW₁ is contacted with either of fixed contacts a₂, a₃ and a₄ thereof, either of the external video signals from the external input terminals EI₁ and EI₂ and the broadcasting signal tuned by the tuner 2 is selectively inputted to the 8 mm deck 3 to be recorded on the 8 mm video tape. Meanwhile, if a common contact of the second switching element SW₂ is contacted with either of fixed contacts b₂, b₃ and b₄ thereof, either of the external video signals from the external input terminals EI₁ and EI₂ and the broadcasting signal tuned by the tuner 2 is selectively inputted to the ½-inch deck 4 to be recorded on the ½-inch video tape.

At the same time, if a common contact of the third switching element SW₃ is contacted with either of fixed contacts c₁ to c₅ thereof, either of the external video signals from the external input terminals EI₁ and EI₂, the output signal of the tuner 2, the output signal of the 8 mm deck 3 and the output signal of the ½-inch deck 4 is selectively outputted to the external output terminal EO and to the modulator 5 as well. The modulator 5 modulates the video signal selected by the third switching element SW₃ and outputs the modulated signal to the TV set through the RF output terminal RFO.

In the meantime, if the common contact of the second switching element SW₂ is contacted with the fixed contact b₁ thereof when a dubbing mode is selected, the video signal reproduced from the 8 mm video tape in the 8 mm deck 3 is outputted to the ½-inch deck 4 through the second switching element SW₂, to be recorded on the ½-inch video tape. Meanwhile, if the common contact of the first switching element SW₁ is contacted with the fixed contact a₁ thereof, and the 8 mm deck 3 and the ½-inch deck 4 are determined to be in a recording mode and in a reproducing mode, respectively, the video signal reproduced from the ½-inch video tape in the ½-inch deck 4 is outputted to the 8 mm deck 3 through the first switching element SW₁, to be recorded on the 8 mm video tape.

However, the conventional multi-deck VCR described as above has the drawbacks in that two decks, i.e., both the 8 mm deck and the ½-inch deck should be provided within a single housing in order to perform a dubbing operation and thus this causes the size of the appliance to be increased and the overall circuitry of the appliance to be complicated, resulting in an increase of the manufacturing cost. Further, every time dubbing is performed, the user should draw the photographed video tape out of the video camera and then insert it into the 8 mm deck of the appliance, making it inconvenient to use.

### SUMMARY OF THE INVENTION

It is an object of the present invention to provide a dubbing control apparatus for video appliances which, without utilizing a multi-deck type video appliance, can perform dubbing between the appliances with the appliances being detachably connected with each other, thereby providing great convenience in use.

In order to achieve the above object, the present invention provides a control apparatus for dubbing video and audio signals recorded/reproduced by first and second video appliances, respectively, the dubbing control apparatus comprising:

first and second connector means, installed on said first and second video appliances, respectively, for being in contact with each other, said first and second connector means interfacing with said video and audio signals recorded/reproduced by said respective first and second video appliances, a data signal, a clock signal, a chip selection signal and a power supply during dubbing; and

switching means for selecting dubbing conditions from said first video appliance to said second video appliance and vice versa.

### BRIEF DESCRIPTION OF THE DRAWINGS

The above object and other features and advantages of the present invention will become more apparent by describing the preferred embodiment thereof with reference to the accompanying drawings, in which:

FIG. 1 is a schematic circuit diagram of a conventional multi-deck video appliance.

FIG. 2 is an explanatory side elevation showing a manner of connecting two video appliances by means of the dubbing control apparatus according to the present invention.

FIG. 3 is a schematic circuit diagram explaining input/output signals of two video appliances connected by means of the dubbing control apparatus according to the present invention.

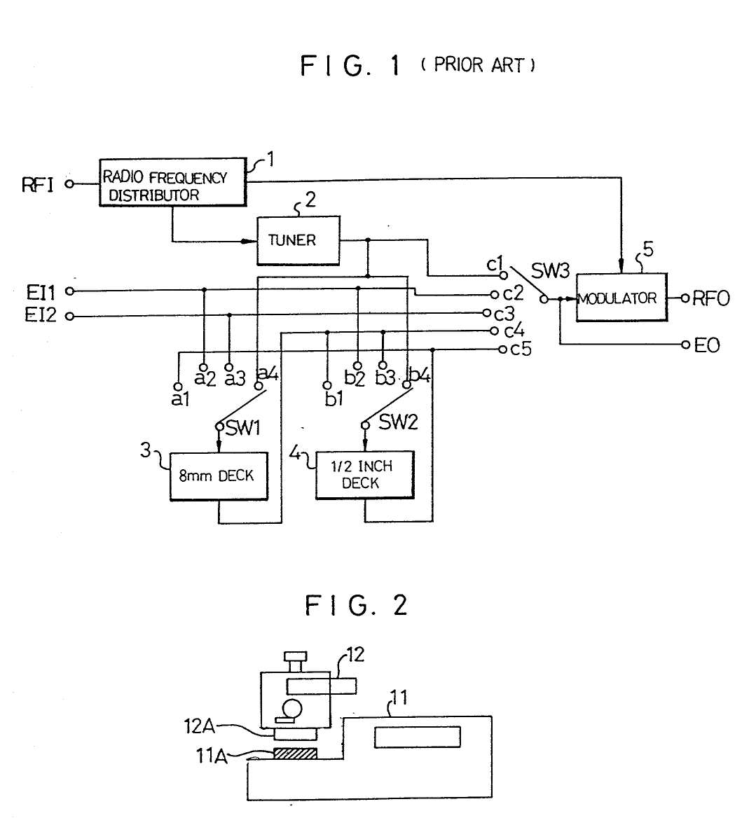

### DETAILED DESCRIPTION OF THE PREFERRED EMBODIMENT

FIG. 2 shows a manner of connecting two video appliances, for example, a fixed VCR and a video camera, by means of the dubbing control apparatus according to the present invention. Referring to FIG. 2, one connector 11A is installed on the upper surface of the fixed VCR 11, and another connector 12A to be connected with the connector 11A is installed on the lower surface of the video camera 12. During a dubbing session, the connectors 11A and 12A are in contact with each other and this causes the video camera 12 to be fixedly mounted on the upper surface of the fixed VCR 11. When connectors 11A and 12A are released from each other, the video camera 12 is separated from the fixed VCR 11. Each of the connectors 11A and 12A may be provided with a cover (not illustrated) for protecting internal terminals thereof while being separated from each other.

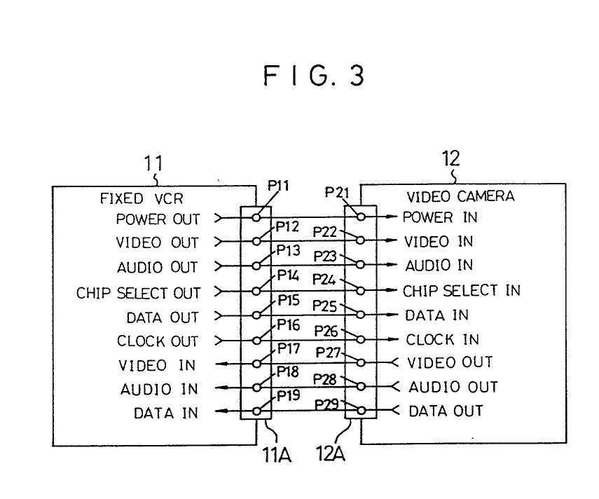

FIG. 3 is a circuit diagram explaining input/output signals of the two appliances connected by the dubbing control apparatus according to the present invention. Referring to FIG. 3, the power supply from the fixed VCR 11 is supplied to the video camera 12 through contacted terminals P₁₁ and P₂₁ of connectors 11A and 12A. Also, if dubbing from the fixed VCR 11 to the video camera 12 is selected, video and audio signals reproduced from the ½-inch video tape in the fixed VCR 11, a chip selection signal, a data signal and a clock signal are respectively inputted to the video camera 12 through contacted terminals P₁₂ to P₁₆, P₂₂ to P₂₆ of the connectors 11A and 12A.

Meanwhile, if dubbing from the video camera 12 to the fixed VCR 11 is selected, video and audio signals reproduced from the 8 mm video tape in the video camera 12 and a data signal are respectively inputted to the fixed VCR 11 through contacted terminals P₂₇ to P₂₉, P₁₇ to P₁₉.

The switching elements for selecting dubbing between the fixed VCR 11 and the video camera 12 may be the same as those used in the conventional multi-deck VCR as described above. It is preferable that the switching elements are provided in the fixed VCR 11.

Now, the operation of the dubbing control apparatus according to the present invention will be explained in detail.

When dubbing between the fixed VCR 11 and the video camera 12 is desired, the user connects the connector 12A installed on the lower surface of the video camera 12 with the connector 11A installed on the upper surface of the fixed VCR. At this time, the terminals P₁₁ to P₁₉ of the fixed VCR 11 are electrically contacted to the terminals P₂₁ to P₂₉ of the video camera 12, respectively, and the power supply from the fixed VCR 11 is provided to the video camera 12 through the contacted terminals P₁₁ and P₂₁ of the fixed VCR 11 and the video camera 12.

At the same time, if the fixed VCR 11 and the video camera 12 are determined by the user to be in a recording mode and in a reproducing mode, respectively, the video camera 12 performs reproduction and the video and audio signals reproduced from the 8 mm video tape are outputted to the fixed VCR 11 through the contacted terminals P₂₇, P₂₈, P₁₇ and P₁₈ of the connectors 12A and 11A. The fixed VCR 11 then records the video and audio signals inputted from the video camera 12 on the ½-inch video tape.

Meanwhile, if the fixed VCR 11 and the video camera 12 are determined to be in a reproducing mode and in a recording mode, respectively, the video and audio signals reproduced from the ½-inch video tape in the fixed VCR 11 are outputted to the video camera 12 through the contacted terminals P₁₂, P₁₃, P₂₂ and P₂₃ of the connectors 11A and 11B, and then the video camera 12 records the video and audio signals inputted from the fixed VCR 11 on the 8 mm video tape.

During the dubbing, as mentioned above, the chip selection signal, the data signal and the clock signal are all inter-faced between the fixed VCR 11 and the video camera 12 through the contacted terminals P₁₄, P₁₅, P₁₆ and P₁₉, P₂₄, P₂₅, P₂₆ and P₂₉ of the connectors 11A and 12A, and thus the user can perform dubbing from the video camera to the fixed VCR and vice versa by means of a single dubbing key.

In the embodiment as described above, it is shown that the chip selection signal and the clock signal are provided from the fixed VCR to the video camera. However, such signals may also be determined to be provided from the video camera to the fixed VCR. Also, it is shown that the video appliances for performing dubbing therebetween are the fixed VCR and the video camera. However, the present invention is not limited thereto and is applicable to all other video appliances for recording/reproducing video and/or audio signals.

As mentioned above, according to the present invention, dubbing can be performed between two video appliances with the appliances being detachably connected with each other, thereby providing great convenience in use, without the necessity of utilizing a costly multi-deck type video appliance.

What is claimed is:

1. A connection arrangement for dubbing video signals between a video cassette recorder and a camcorder, comprising:
a first housing comprising the video cassette recorder, said first housing having an upper surface;
a second housing comprising the camcorder;
a first connector attached to said first housing and electrically connected to said video cassette recorder; and
a second connector attached to said second housing and electrically connected to said camcorder, said second connector being adapted to physically engage said first connector when said second housing is placed on the upper surface of said first housing, and thereby provide an electrical connection between the video cassette recorder and the camcorder.

2. The connection arrangement of claim 1 wherein said first and second connectors are aligned on their respective housings so that said connectors become physically engaged when said first and second housings are brought together in an operative condition.

3. The connection arrangement of claim 1 wherein power is supplied to the camcorder from the video cassette recorder when said first and second connectors are physically engaged.

4. The connection arrangement of claim 1 wherein said second connector is adapted to physically disengage said first connector when said second housing is lifted from the upper surface of said first housing in a direction normal to the upper surface.

5. The connection arrangement of claim 1 wherein said first connector is attached to the upper surface of said first housing.

6. The connection arrangement of claim 1 wherein said second housing further comprises a lower surface, and said second connector is attached to said lower surface.

7. A connection arrangement for dubbing video signals between a video cassette recorder and an 8 mm camcorder, comprising:
a first housing comprising the video cassette recorder, said first housing having an upper surface;
a second housing comprising the 8 mm camcorder;
a first connector attached to said first housing and electrically connected to said video cassette recorder; and
a second connector attached to said second housing and electrically connected to said 8 mm camcorder, said second connector being adapted to physically engage said first connector when said second housing is placed on the upper surface of said first housing, and thereby provide an electrical connection between the video cassette recorder and the 8 mm camcorder.

8. The connection arrangement of claim 7 wherein said first and second connectors are aligned on their respective housings so that said connectors become physically engaged when said first and second housings are brought together in an operative condition.

9. The connection arrangement of claim 7 wherein power is supplied to the 8 mm camcorder from the video cassette recorder when said first and second connectors are physically engaged.

10. The connection arrangement of claim 7 wherein said second connector is adapted to physically disengage said first connector when said second housing is lifted from the upper surface of said first housing in a direction normal to the upper surface.

11. The connection arrangement of claim 7 wherein said first connector is attached to the upper surface of said first housing.

12. The connection arrangement of claim 7 wherein said second housing further comprises a lower surface, and said second connector is attached to said lower surface.
